(19) United States
(12) Patent Application Publication
(10) Pub. No.: US 2024/0036437 A1
(43) Pub. Date: Feb. 1, 2024

(54) CAMERA MODULE

(71) Applicant: Murata Manufacturing Co., Ltd., Nagaokakyo-shi (JP)

(72) Inventor: Daisuke NAKAMURA, Nagaokakyo-shi (JP)

(21) Appl. No.: 18/377,325

(22) Filed: Oct. 6, 2023

Related U.S. Application Data
(63) Continuation of application No. PCT/JP2022/000932, filed on Jan. 13, 2022.

(30) Foreign Application Priority Data
Apr. 13, 2021 (JP) 2021-067416

(51) Int. Cl. G03B 5/02; H04N 23/68; H04N 23/54; H02K 11/215; H02K 41/035

(52) U.S. Cl. CPC G03B 5/02; H04N 23/685; H04N 23/6812; H04N 23/54; H02K 11/215; H02K 41/0354; G03B 2205/0038; G03B 2205/0069

(57) ABSTRACT

In a camera module, by four first coils and four first magnets, a driving force to cause a lens module to move in a direction of an optical axis can be generated. By four second coils and the four first magnets, a driving force to cause a substrate to move in a first direction in an in-plane direction orthogonal to the direction of optical axis, a driving force to cause the substrate to move in a second direction that is orthogonal to each of the direction of optical axis and the first direction, and a driving force to cause the substrate to rotate about optical axis can be generated.

### CROSS REFERENCE TO RELATED APPLICATIONS

This application claims the benefit of priority to Japanese Patent Application No. 2021-067416 filed on Apr. 13, 2021 and is a Continuation Application of PCT Application No. PCT/JP2022/000932 filed on Jan. 13, 2022. The entire contents of each application are hereby incorporated herein by reference.

### BACKGROUND OF THE INVENTION

### 1. Field of the Invention

The present invention relates to a camera module.

### 2. Description of the Related Art

Japanese Patent Laid-Open No. 2019-28340 is a reference disclosing a structure of a camera module. The camera module according to Japanese Patent Laid-Open No. 2019-28340 includes an AF (Autofocus) actuator and an OIS (Optical Image Stabilization) actuator that corrects shaking in three axis directions including an X-axis direction, a Y-axis direction, and a direction around a Z-axis. The AF actuator and the OIS actuator are formed by different voice coil motors.

### SUMMARY OF THE INVENTION

In a case of configuring the AF mechanism and the OIS mechanism with different voice coil motors, the number of components increases, making it difficult to reduce the size of the camera module.

Preferred embodiments of the present invention provide camera modules each having an OIS function to correct shaking in three axis directions and an AF function, and having the size reduced using fewer components.

A camera module according to a preferred embodiment of the present invention includes four first magnets, a lens module, four first coils, four second coils, four first magnetic sensors, a second magnetic sensor, a third magnetic sensor, a second magnet, and a fourth magnetic sensor. The four first magnets are provided on a fixed portion with a position fixed and are positioned with a space therebetween. The lens module includes a lens with an optical axis and is movable in a direction of the optical axis relative to the fixed portion. The four first coils are positioned on the lens module so as to respectively face the four first magnets. A substrate is movably supported with respect to the fixed portion and includes an image sensor mounted thereon. The four second coils are positioned on the substrate so as to respectively face the four first magnets. The first magnetic sensor is positioned on the substrate so as to face one first magnet of the four first magnets and to detect a strength of a magnetic field to be applied from this first magnet. The second magnetic sensor is positioned on the substrate so as to face one first magnet of the four first magnets and to detect the strength of the magnetic field to be applied from this first magnet. The third magnetic sensor is positioned on the substrate so as to face one first magnet of the four first magnets and to detect a displacement in an application direction of the magnetic field to be applied from this first magnet in an in-plane direction that is orthogonal to the direction of the optical axis. The second magnet is provided on one of the lens module and the fixed portion. The fourth magnetic sensor is positioned on the other of the lens module and the fixed portion so as to face the second magnet and to detect a strength of a magnetic field to be applied from the second magnet. The four first coils and the four first magnets are operable to generate a driving force to cause the lens module to move in the direction of the optical axis. The four second coils and the four first magnets are operable to generate a driving force to cause the substrate to move in a first direction in the in-plane direction, a driving force to cause the substrate to move in a second direction that is orthogonal to each of the direction of the optical axis and the first direction, and a driving force to cause the substrate to rotate about the optical axis. A displacement of the substrate in the first direction is detected based on the strength of the magnetic field detected by the first magnetic sensor. A displacement of the substrate in the second direction is detected based on the strength of the magnetic field detected by the second magnetic sensor. A displacement of the substrate around the optical axis is detected based on the displacement of the magnetic field in the application direction detected by the third magnetic sensor. A displacement of the lens module in the direction of the optical axis is detected based on the strength of the magnetic field detected by the fourth magnetic sensor.

According to each of preferred embodiments of the present invention, the number of components in the camera module with the OIS function to correct shaking in the three axis directions and the AF function can be reduced, so that the size can be reduced.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a perspective view illustrating a structure of a camera module according to a preferred embodiment of the present invention.

FIG. 2 is a side view in which the camera module in FIG. 1 is viewed from an arrow II direction.

FIG. 3 is a perspective view in which a lens module, a fixed portion, and first coils are seen through in the camera module according to a preferred embodiment of the present invention.

FIG. 4 is a perspective view illustrating a structure on a substrate included in a camera module according to a preferred embodiment of the present invention.

FIG. 5 is a block diagram illustrating a structure related to control of the lens module in a camera module according to a preferred embodiment of the present invention.

FIG. 6 is a perspective view illustrating a state in which a driving force to cause the lens module to move in a direction of an optical axis is generated in a camera module according to a preferred embodiment of the present invention.

FIG. 7 is a cross-sectional view viewed from a VII-VII line arrow direction in FIG. 6.

FIG. 8 is a perspective view illustrating a state in which a driving force to cause the substrate to move in a first direction (X-axis direction) is generated in the camera module according to a preferred embodiment of the present invention.

FIG. 9 is a cross-sectional view viewed from a IX-IX line arrow direction in FIG. 8.

FIG. 10 is a perspective view illustrating a state in which a driving force to cause the substrate to move in a second direction (Y-axis direction) is generated in the camera module according to a preferred embodiment of the present invention.

FIG. 11 is a cross-sectional view viewed from a XI-XI line arrow direction in FIG. 10.

FIG. 12 is a perspective view illustrating a state in which a driving force to cause the substrate to rotate about an optical axis is generated in a camera module according to a preferred embodiment of the present invention.

FIG. 13 is a cross-sectional view viewed from a XIII-XIII line arrow direction in FIG. 12.

### DETAILED DESCRIPTION OF THE PREFERRED EMBODIMENTS

With reference to the drawings, camera modules according to preferred embodiments of the present invention will hereinafter be described. In the descriptions of the preferred embodiments below, the same or corresponding components throughout the drawings will be denoted by the same reference sign and the description thereof will not be repeated. In the descriptions of the camera modules below, the positional relation such as an up-down relation is based on the camera modules in the examples each with a lens facing upward for the convenience.

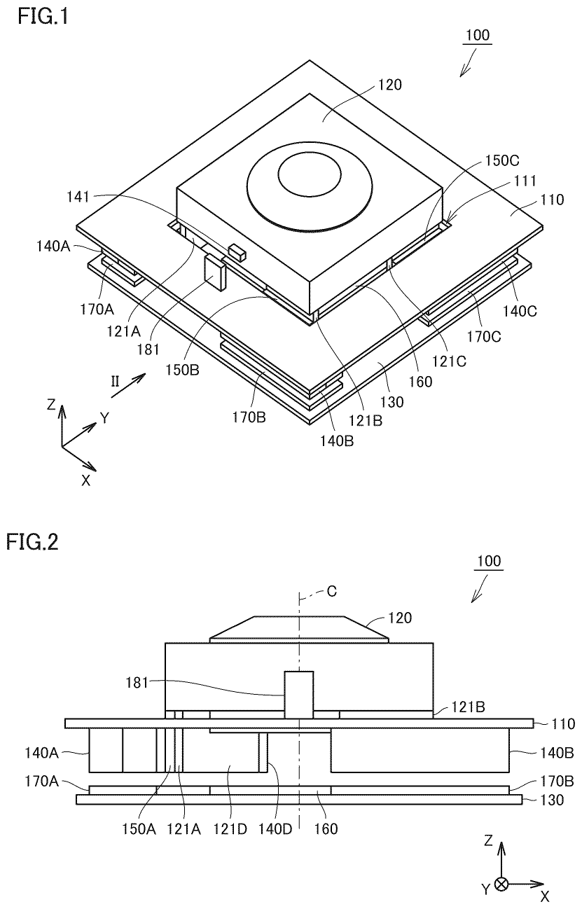

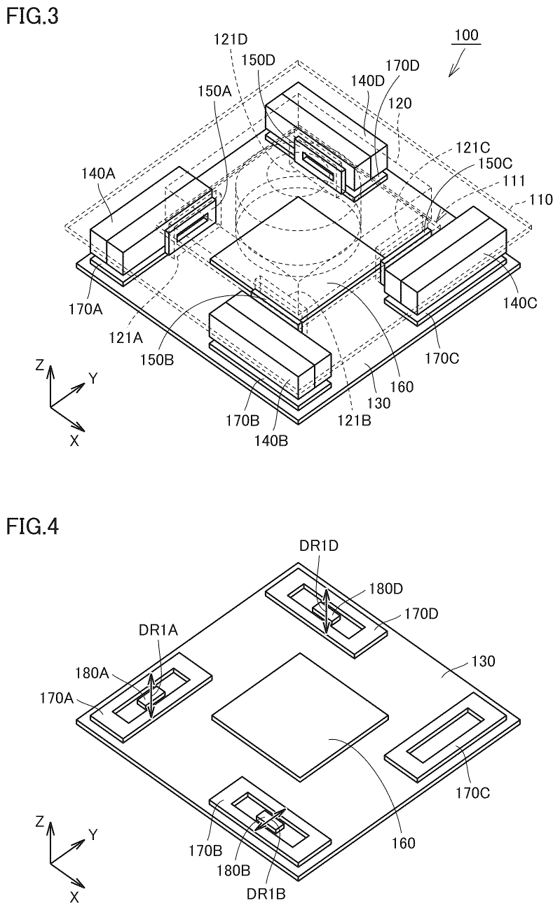

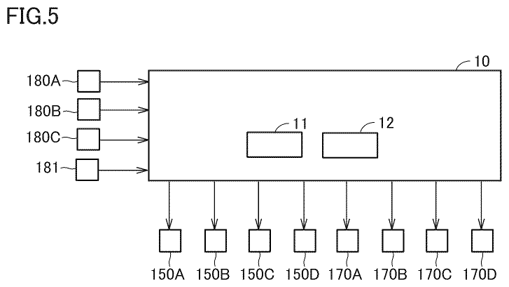

FIG. 1 is a perspective view illustrating a structure of a camera module according to a preferred embodiment of the present invention. FIG. 2 is a side view in which the camera module in FIG. 1 is viewed from an arrow II direction. FIG. 3 is a perspective view in which a lens module, a fixed portion, and first coils are seen through in a camera module according to a preferred embodiment of the present invention. FIG. 4 is a perspective view illustrating a structure on a substrate in a camera module according to a preferred embodiment of the present invention.

In FIG. 1 to FIG. 4, a direction of an optical axis of a lens is shown as a Z-axis direction, a first direction in an in-plane direction (XY direction) that is orthogonal to the direction of the optical axis (Z-axis direction) is shown as an X-axis direction, and a second direction that is orthogonal to each of the direction of the optical axis (Z-axis direction) and the first direction (X-axis direction) is shown as a Y-axis direction.

As illustrated in FIG. 1 to FIG. 4, a camera module 100 according to a preferred embodiment of the present invention includes four first magnets 140A to 140D, a lens module 120, four first coils 150A to 150D, a substrate 130, four second coils 170A to 170D, a first magnetic sensor 180A, a second magnetic sensor 180D, a third magnetic sensor 180B, a second magnet 141, and a fourth magnetic sensor 181.

As illustrated in FIG. 1 to FIG. 3, camera module 100 further includes a fixed portion 110 with the position fixed. Fixed portion 110 is a rectangular or substantially rectangular flat plate including an opening 111 with a rectangular or substantially rectangular shape at a center.

As illustrated in FIG. 2, lens module 120 includes a lens with an optical axis C, and is movable in the direction of optical axis C (Z-axis direction) relative to fixed portion 110. As illustrated in FIG. 1, lens module 120 exists inside opening 111 when viewed from the direction of optical axis C (Z-axis direction). As illustrated in FIG. 1 to FIG. 3, lens module 120 has an approximately cuboid external shape.

Lens module 120 includes four leg portions 121A to 121D extending to the place below fixed portion 110 through opening 111. Each of four leg portions 121A to 121D extends in a shape of a flat plate in the Z-axis direction.

Each of four first magnets 140A to 140D is fixed to a lower surface of fixed portion 110. Four first magnets 140A to 140D are positioned with a space therebetween. Each of four first magnets 140A to 140D has a cuboid shape. Four first magnets 140A to 140D are positioned to have 4-fold rotational symmetry about optical axis C when viewed from the direction of optical axis C (Z-axis direction). Four first magnets 140A to 140D are not disposed line symmetrically when viewed from the direction of optical axis C (Z-axis direction). First magnets 140A and 140C have their longitudinal directions extending in the Y-axis direction, and first magnets 140B and 140D have their longitudinal directions extending in the X-axis direction.

In this preferred embodiment, each of four first magnets 140A to 140D is a quadrupole magnet, for example. However, each of four first magnets 140A to 140D may be a dipole magnet, for example.

Four first coils 150A to 150D are disposed on lens module 120 so as to face four first magnets 140A to 140D, respectively. Specifically, four first coils 150A to 150D are fixed to four leg portions 121A to 121D of lens module 120, respectively. First coil 150A is fixed to leg portion 121A and faces a side surface of first magnet 140A. First coil 150B is fixed to leg portion 121B and faces a side surface of first magnet 140B. First coil 150C is fixed to leg portion 121C and faces a side surface of first magnet 140C. First coil 150D is fixed to leg portion 121D and faces a side surface of first magnet 140D.

A first voice coil motor includes first coil 150A and first magnet 140A that face each other. A first voice coil motor includes first coil 150B and first magnet 140B that face each other. A first voice coil motor includes first coil 150C and first magnet 140C that face each other. A first voice coil motor includes first coil 150D and first magnet 140D that face each other. By these four first voice coil motors, a driving force to cause lens module 120 to move in the direction of optical axis C (Z-axis direction) can be generated.

Substrate 130 is supported movably to fixed portion 110 with a supporting mechanism that is not shown. As illustrated in FIG. 2 to FIG. 4, substrate 130 is disposed in parallel to fixed portion 110. Substrate 130 extends in the in-plane direction (XY direction) that is orthogonal to the direction of optical axis C (Z-axis direction). Substrate 130 has a rectangular or substantially rectangular shape. Substrate 130 includes an image sensor 160 mounted thereon. Image sensor 160 receives light from an optical element of lens module 120 and converts the received light into electric signals.

As illustrated in FIG. 1 to FIG. 4, four second coils 170A to 170D are positioned on substrate 130 so as to face four first magnets 140A to 140D, respectively. Four second coils 170A to 170D are positioned to have 4-fold rotational symmetry when viewed from the direction of optical axis C (Z-axis direction). Specifically, second coil 170A faces a lower surface of first magnet 140A. Second coil 170B faces a lower surface of first magnet 140B. Second coil 170C faces a lower surface of first magnet 140C. Second coil 170D faces a lower surface of first magnet 140D.

A second voice coil motor includes second coil 170A and first magnet 140A that face each other. A second voice coil motor includes second coil 170B and first magnet 140B that face each other. A second voice coil motor includes second coil 170C and first magnet 140C that face each other. A second voice coil motor includes second coil 170D and first magnet 140D that face each other.

By these four second voice coil motors, the driving force to cause substrate 130 to move in the first direction (X-axis direction), the driving force to cause substrate 130 to move in the second direction (Y-axis direction), and the driving force to cause substrate 130 to rotate about optical axis C can be generated.

As illustrated in FIG. 3 and FIG. 4, first magnetic sensor 180A is positioned on substrate 130 so as to face first magnet 140A corresponding to one of four first magnets 140A to 140D, and to detect the strength of the magnetic field to be applied from first magnet 140A. First magnetic sensor 180A has a sensitivity axis DR1A along the direction of optical axis C (Z-axis direction). In this preferred embodiment, first magnetic sensor 180A is disposed inside second coil 170A. However, first magnetic sensor 180A may be disposed outside second coil 170A within the range of facing first magnet 140A.

Second magnetic sensor 180D is positioned on substrate 130 so as to face first magnet 140D corresponding to one of four first magnets 140A to 140D, and to detect the strength of the magnetic field to be applied from first magnet 140D. Second magnetic sensor 180D has a sensitivity axis DR1D along the direction of optical axis C (Z-axis direction). In this preferred embodiment, second magnetic sensor 180D is disposed inside second coil 170D. However, second magnetic sensor 180D may be disposed outside second coil 170D within the range of facing first magnet 140D.

Third magnetic sensor 180B is positioned on substrate 130 so as to face first magnet 140B corresponding to one of four first magnets 140A to 140D, and to detect the displacement in an application direction of the magnetic field to be applied from first magnet 140B in the in-plane direction (XY direction). Third magnetic sensor 180B has a sensitivity axis DRIB along the second direction (Y-axis direction). In this preferred embodiment, third magnetic sensor 180B is disposed inside second coil 170B. However, third magnetic sensor 180B may be disposed outside second coil 170B within the range of facing first magnet 140B.

Second magnet 141 is provided on a side surface of lens module 120. Second magnet 141 has a cuboid shape. The magnetization direction of second magnet 141 is along the X-axis direction. Note that second magnet 141 may be provided on fixed portion 110. Second magnet 141 is smaller than first magnets 140A to 140D, and the magnetic field of second magnet 141 does not affect each of the first voice coil motor and the second voice coil motor.

Fourth magnetic sensor 181 is positioned on fixed portion 110 so as to face second magnet 141, and to detect the strength of the magnetic field to be applied from second magnet 141. Fourth magnetic sensor 181 has a sensitivity axis along the second direction (Y-axis direction). In the case where second magnet 141 is provided on fixed portion 110, fourth magnetic sensor 181 may be provided on a side surface of lens module 120.

Each of first magnetic sensor 180A to fourth magnetic sensor 181 includes a plurality of magnetic resistance effect elements defining a bridge circuit. In this preferred embodiment, the magnetic resistance effect element is a TMR (Tunnel Magneto Resistance) element. The magnetic resistance effect element may be a GMR (Giant Magneto Resistance) element, an AMR (Anisotropic Magneto Resistance) element, or the like. Moreover, each of first magnetic sensor 180A to fourth magnetic sensor 181 may include a Hall element instead of the magnetic resistance effect element.

FIG. 5 is a block diagram illustrating a structure related to the control of a lens module in a camera module according to a preferred embodiment of the present invention. As illustrated in FIG. 5, camera module 100 further includes a control unit 10.

Control unit 10 includes a CPU (Central Processing Unit) 11, a memory 12 including a ROM (Read Only Memory) and a RAM (Random Access Memory), and additionally an input-output buffer (not shown) to input and output various signals, and the like. CPU 11 develops programs, which are stored in the ROM, in the RAM or the like and executes the programs. The programs stored in the ROM are the programs containing the procedure of the process of control unit 10. In accordance with these programs, control unit executes the control of the appliance in camera module 100. The control as above is not limited to the process by software and may be processed by dedicated hardware (electronic circuit). Control unit 10 is provided on substrate 130, for example.

To control unit 10, detection signals resulting from the detection of the magnetic fields from first magnetic sensor 180A to fourth magnetic sensor 181 are input. Control unit 10 detects the displacement of substrate 130 in the first direction (X-axis direction) on the basis of the strength of the magnetic field detected by first magnetic sensor 180A. Control unit 10 detects the displacement of substrate 130 in the second direction (Y-axis direction) on the basis of the strength of the magnetic field detected by second magnetic sensor 180D.

Control unit 10 detects the displacement of substrate 130 around optical axis C on the basis of the displacement, in the application direction, of the magnetic field detected by third magnetic sensor 180B. Based on the strength of the magnetic field detected by fourth magnetic sensor 181, the displacement of lens module 120 in the direction of optical axis C (Z-axis direction) is detected.

In the case of causing lens module 120 to move in the direction of optical axis C (Z-axis direction) for the AF function, control unit 10 causes current to flow in each of four first coils 150A to 150D, thereby driving the four first voice coil motors.

In the case of causing lens module 120 to move in the first direction (X-axis direction), in the second direction (Y-axis direction), and around optical axis C for the OIS function to correct shaking in the three axis directions, control unit 10 causes current to flow in each of four second coils 170A to 170D, thereby driving the four second voice coil motors.

By controlling the direction of the current and the current value individually about the current to be supplied to four second coils 170A to 170D, control unit 10 controls the four second voice coil motors individually.

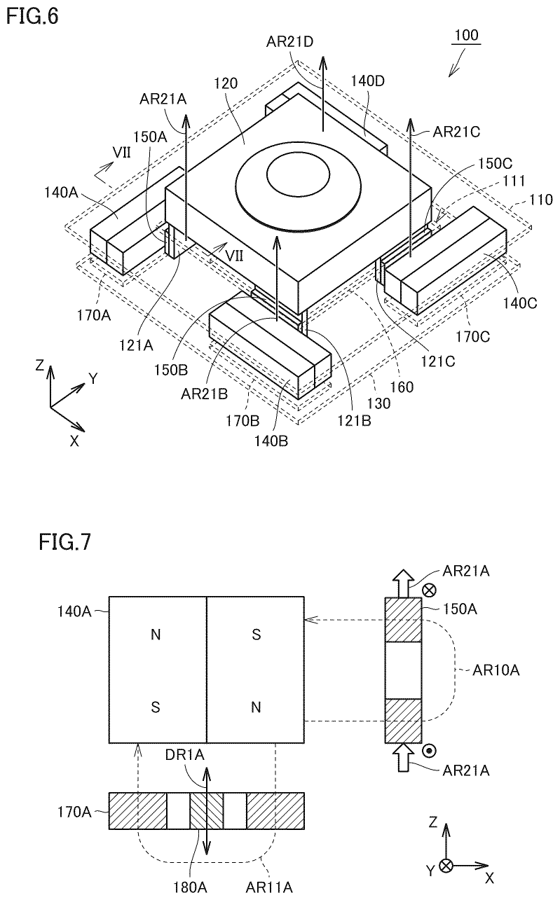

FIG. 6 is a perspective view illustrating a state in which the driving force to cause the lens module to move in the direction of the optical axis is generated in a camera module according to a preferred embodiment of the present invention. FIG. 7 is a cross-sectional view viewed from a VII-VII line arrow direction in FIG. 6.

Control unit 10 executes the control to achieve the AF function by making the direction of current to be supplied and the current value the same for all four first coils 150A to 150D. Thus, as illustrated in FIG. 6 and FIG. 7, driving forces AR21A to AR21D to cause lens module 120 to move in the direction of optical axis C (Z-axis direction) are generated in the four first voice coil motors.

The mechanism about the generation of the driving force is described regarding first coil 150A, for example. As illustrated in FIG. 7, a magnetic field AR10A of first magnet 140A is applied to first coil 150A. At an upper portion of first coil 150A, driving force AR21A is generated in a positive direction of the Z-axis direction by the current flowing in a positive direction of the Y-axis direction and the magnetic field acting in a negative direction of the X-axis direction. Similarly, at a lower portion of first coil 150A, driving force AR21A is generated in the positive direction of the Z-axis direction by the current flowing in a negative direction of the Y-axis direction and the magnetic field acting in a positive direction of the X-axis direction.

Reversing the direction of the current to be supplied to first coil 150A generates driving force AR21A in the negative direction of the Z-axis direction. In this manner, the four first voice coil motors can drive lens module 120 back and forth in the direction of optical axis C (Z-axis direction).

Fourth magnetic sensor 181 illustrated in FIG. 1 detects the strength of the magnetic field component in the Z-axis direction of the magnetic field of second magnet 141. As second magnet 141 moves in the direction of optical axis C (Z-axis direction) together with lens module 120, the strength of the magnetic field component in the Z-axis direction of the magnetic field of second magnet 141 that is detected by fourth magnetic sensor 181 changes. Control unit 10 detects the displacement of lens module 120 in the direction of optical axis C (Z-axis direction) on the basis of the strength of the magnetic field component in the Z-axis direction of the magnetic field of second magnet 141 that is detected by fourth magnetic sensor 181. Based on the detected displacement of lens module 120 in the direction of optical axis C (Z-axis direction), control unit 10 executes the feedback control of adjusting the current value to be supplied to four first coils 150A to 150D.

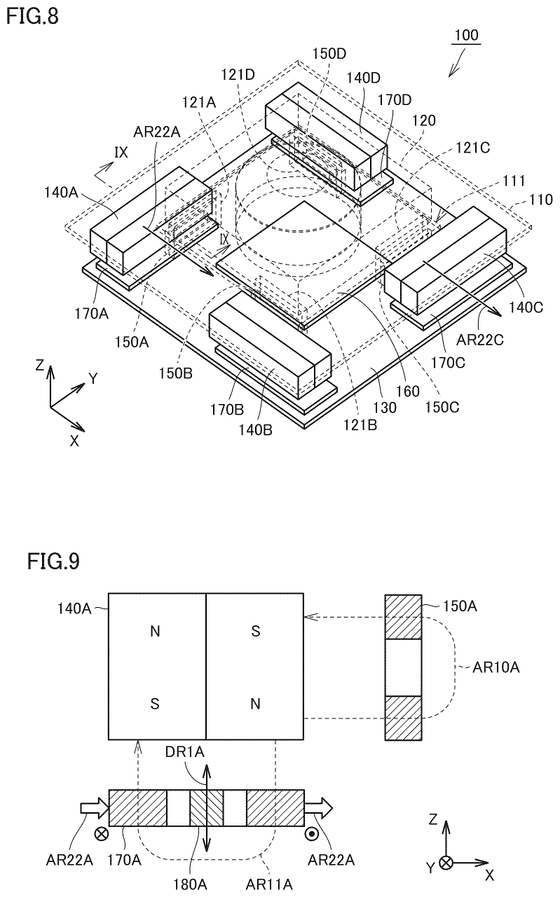

FIG. 8 is a perspective view illustrating a state in which the driving force to cause the substrate to move in the first direction (X-axis direction) is generated in a camera module according to a preferred embodiment of the present invention. FIG. 9 is a cross-sectional view viewed from a IX-IX line arrow direction in FIG. 8.

Control unit 10 executes the control to achieve the OIS function to correct shaking in the X-axis direction by making the direction of current to be supplied and the current value the same for second coil 170A and second coil 170C. Accordingly, as illustrated in FIG. 8 and FIG. 9, driving forces AR22A and AR22C to cause substrate 130 to move in the first direction (X-axis direction) are generated in the two second voice coil motors.

The mechanism about the generation of the driving force is described regarding second coil 170A, for example. As illustrated in FIG. 9, a magnetic field AR11A of first magnet 140A is applied to second coil 170A. At a right portion of second coil 170A, driving force AR22A is generated in the positive direction of the X-axis direction by the current flowing in the negative direction of the Y-axis direction and the magnetic field acting in the negative direction of the Z-axis direction. Similarly, at a left portion of second coil 170A, driving force AR22A is generated in the positive direction of the X-axis direction by the current flowing in the positive direction of the Y-axis direction and the magnetic field acting in the positive direction of the Z-axis direction.

Reversing the direction of the current to be supplied to second coil 170A generates driving force AR22A in the negative direction of the X-axis direction. In this manner, the two second voice coil motors can drive substrate 130 back and forth in the first direction (X-axis direction).

As illustrated in FIG. 7, first magnetic sensor 180A detects the strength of the magnetic field component in the Z-axis direction of magnetic field AR11A of first magnet 140A. As first magnetic sensor 180A moves in the X-axis direction together with substrate 130, the strength of the magnetic field component in the Z-axis direction of magnetic field AR11A that is detected by first magnetic sensor 180A changes. Control unit 10 detects the displacement of substrate 130 in the first direction (X-axis direction) on the basis of the strength of the magnetic field component in the Z-axis direction of magnetic field AR11A that is detected by first magnetic sensor 180A. Based on the detected displacement of substrate 130 in the first direction (X-axis direction), control unit 10 executes the feedback control of adjusting the current value to be supplied to second coil 170A and second coil 170C.

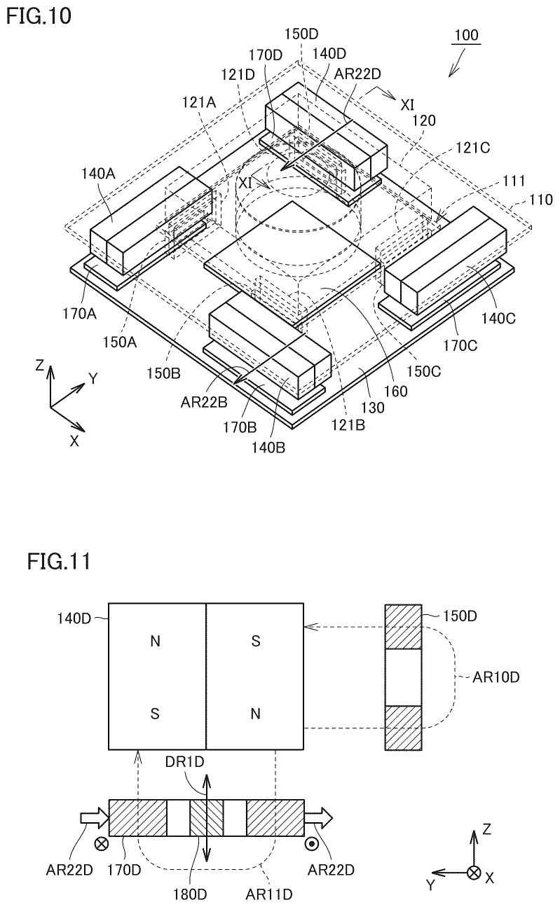

FIG. 10 is a perspective view illustrating a state in which the driving force to cause the substrate to move in the second direction (Y-axis direction) is generated in a camera module according to a preferred embodiment of the present invention. FIG. 11 is a cross-sectional view viewed from a XI-XI line arrow direction in FIG. 10.

Control unit 10 executes the control to achieve the OIS function to correct shaking in the Y-axis direction by making the direction of current to be supplied and the current value the same for second coil 170B and second coil 170D. Accordingly, as illustrated in FIG. 10 and FIG. 11, driving forces AR22B and AR22D to cause substrate 130 to move in the second direction (Y-axis direction) are generated in the two second voice coil motors.

The mechanism about the generation of the driving force is described regarding second coil 170D, for example. As illustrated in FIG. 11, a magnetic field AR11D of first magnet 140D is applied to second coil 170D. At a right portion of second coil 170D, driving force AR22D is generated in the negative direction of the Y-axis direction by the current flowing in the negative direction of the X-axis direction and the magnetic field acting in the negative direction of the Z-axis direction. Similarly, at a left portion of second coil 170D, driving force AR22D is generated in the negative direction of the Y-axis direction by the current flowing in the positive direction of the X-axis direction and the magnetic field acting in the positive direction of the Z-axis direction.

Reversing the direction of the current to be supplied to second coil 170D generates driving force AR22D in the positive direction of the Y-axis direction. In this manner, the two second voice coil motors can drive substrate 130 back and forth in the second direction (Y-axis direction).

As illustrated in FIG. 11, second magnetic sensor 180D detects the strength of the magnetic field component in the Z-axis direction of magnetic field AR11D of first magnet 140D. As second magnetic sensor 180D moves in the Y-axis direction together with substrate 130, the strength of the magnetic field component in the Z-axis direction of magnetic field AR11D that is detected by second magnetic sensor 180D changes. Control unit 10 detects the displacement of substrate 130 in the second direction (Y-axis direction) on the basis of the strength of the magnetic field component in the Z-axis direction of magnetic field AR11D that is detected by second magnetic sensor 180D. Based on the detected displacement of substrate 130 in the second direction (Y-axis direction), control unit 10 executes the feedback control of adjusting the current value to be supplied to second coil 170B and second coil 170D.

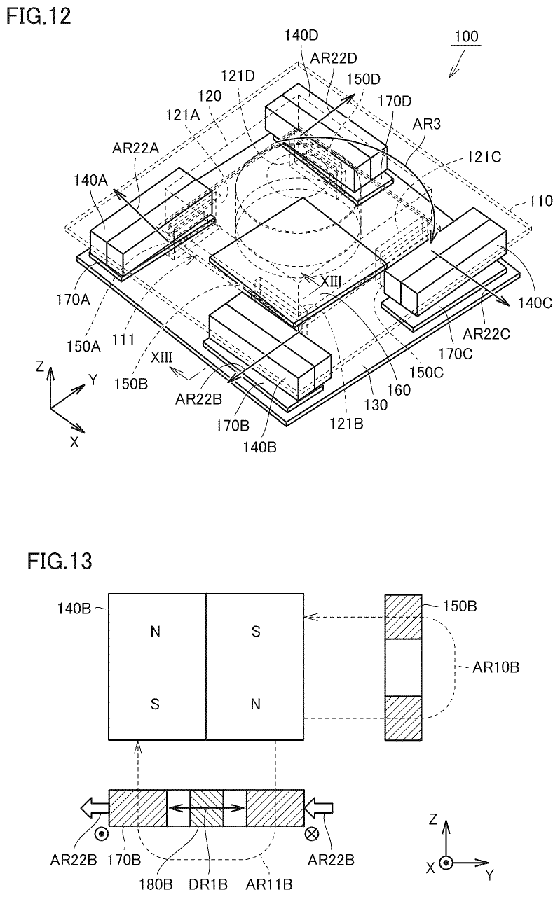

FIG. 12 is a perspective view illustrating a state in which the driving force to cause the substrate to rotate about the optical axis is generated in a camera module according to a preferred embodiment of the present invention. FIG. 13 is a cross-sectional view viewed from a XIII-XIII line arrow direction in FIG. 12.

Control unit 10 executes the control to achieve the OIS function to correct shaking around optical axis C by making the directions of current to be supplied to second coil 170A and second coil 170C opposite, and making the directions of current to be supplied to second coil 170B and second coil 170D opposite. Thus, as illustrated in FIG. 12 and FIG. 13, driving forces AR22A to AR22D to cause substrate 130 to rotate about optical axis C are generated in the four second voice coil motors. Driving forces AR22A to AR22D are combined into a rotation driving force AR3.

The mechanism about the generation of the driving force is described regarding second coil 170B, for example. As illustrated in FIG. 13, a magnetic field AR11B of first magnet 140B is applied to second coil 170B. At a right portion of second coil 170B, driving force AR22B is generated in the negative direction of the Y-axis direction by the current flowing in the negative direction of the X-axis direction and the magnetic field acting in the negative direction of the Z-axis direction. Similarly, at a left portion of second coil 170B, driving force AR22B is generated in the negative direction of the Y-axis direction by the current flowing in the positive direction of the X-axis direction and the magnetic field acting in the positive direction of the Z-axis direction.

Reversing the direction of the current to be supplied to second coil 170B generates driving force AR22B in the positive direction of the Y-axis direction. As a result, the direction of rotation driving force AR3 also becomes opposite. Thus, the four second voice coil motors can swing and drive substrate 130 around optical axis C.

As illustrated in FIG. 13, third magnetic sensor 180B detects the displacement, in the application direction, of magnetic field AR11B of first magnet 140B in the in-plane direction (XY direction). As third magnetic sensor 180B rotates about optical axis C together with substrate 130, the application direction of magnetic field AR11B that is detected by third magnetic sensor 180B in the in-plane direction (XY direction) changes. Control unit 10 detects the displacement of substrate 130 around optical axis C on the basis of the displacement, in the application direction, of magnetic field AR11B that is detected by third magnetic sensor 180B in the in-plane direction (XY direction). Based on the detected displacement of substrate 130 around optical axis C, control unit 10 executes the feedback control of adjusting the current value to be supplied to four second coils 170A to 170D.

In camera module 100 according to a preferred embodiment of the present invention, four first magnets 140A to 140D are provided on fixed portion 110 with the position fixed, and are positioned with a space therebetween. Lens module 120 includes the lens with optical axis C, and is movable in the direction of optical axis C (Z-axis direction) relative to fixed portion 110. Four first coils 150A to 150D are disposed on lens module 120 so as to face four first magnets 140A to 140D, respectively. Substrate 130 is movably supported with respect to fixed portion 110, and has image sensor 160 mounted thereon. Four second coils 170A to 170D are positioned on substrate 130 so as to face four first magnets 140A to 140D, respectively. First magnetic sensor 180A is positioned on substrate 130 so as to face first magnet 140A corresponding to one of four first magnets 140A to 140D, and to detect the strength of the magnetic field to be applied from this first magnet 140A. Second magnetic sensor 180D is positioned on substrate 130 so as to face first magnet 140D corresponding to one of four first magnets 140A to 140D, and to detect the strength of the magnetic field to be applied from this first magnet 140D. Third magnetic sensor 180B is positioned on substrate 130 so as to face first magnet 140B corresponding to one of four first magnets 140A to 140D, and to detect the displacement, in the application direction, of the magnetic field to be applied from this first magnet 140B in the in-plane direction (XY direction). Second magnet 141 is provided on one of lens module 120 and fixed portion 110. Fourth magnetic sensor 181 is disposed on the other of lens module 120 and fixed portion 110 so as to face second magnet 141, and to detect the strength of the magnetic field to be applied from second magnet 141. By four first coils 150A to 150D and four first magnets 140A to 140D, the driving force to cause lens module 120 to move in the direction of optical axis C (Z-axis direction) can be generated. By four second coils 170A to 170D and four first magnets 140A to 140D, the driving force to cause substrate 130 to move in the first direction (X-axis direction) in the in-plane direction (XY direction) that is orthogonal to the direction of optical axis C (Z-axis direction), the driving force to cause substrate 130 to move in the second direction (Y-axis direction) that is orthogonal to each of the direction of optical axis C (Z-axis direction) and the first direction (X-axis direction), and the driving force to cause substrate 130 to rotate about optical axis C can be generated. Based on the strength of the magnetic field detected by first magnetic sensor 180A, the displacement of substrate 130 in the first direction (X-axis direction) is detected. Based on the strength of the magnetic field detected by second magnetic sensor 180D, the displacement of substrate 130 in the second direction (Y-axis direction) is detected. Based on the displacement, in the application direction, of the magnetic field detected by third magnetic sensor 180B, the displacement of substrate 130 around optical axis C is detected. Based on the strength of the magnetic field detected by fourth magnetic sensor 181, the displacement of lens module 120 in the direction of optical axis C (Z-axis direction) is detected.

Thus, the number of components in camera module 100 with the OIS function to correct shaking in the three axis directions and the AF function can be reduced, so that the size can be reduced. In addition, since fixing four first magnets 140A to 140D to fixed portion 110 can reduce the weight of the movable portion including lens module 120 and substrate 130, the movable portion can be driven with smaller driving force. Furthermore, by correcting shaking in the three axis directions mechanically, OIS to correct the shaking in the three axis directions can be executed without reducing the amount of information in image information compared to the case of correcting the shaking in the three axis directions by performing information processing on an image signal acquired from image sensor 160.

In camera module 100 according to a preferred embodiment of the present invention, four first magnets 140A to 140D are positioned to have 4-fold rotational symmetry about optical axis C when viewed from the direction of optical axis C (Z-axis direction). Thus, the magnetic field to generate the driving force to rotate and drive substrate 130 about optical axis C can act on four second coils 170A to 170D.

In camera module 100 according to a preferred embodiment of the present invention, four second coils 170A to 170D are positioned to have 4-fold rotational symmetry when viewed from the direction of optical axis C (Z-axis direction). Thus, the driving force to rotate and drive substrate 130 about optical axis C can be generated.

In camera module 100 according to a preferred embodiment of the present invention, each of four first magnets 140A to 140D is a quadrupole magnet. Thus, one first magnet can be commonly used as the magnets of the first voice coil motor and the second voice coil motor with a simple structure.

In camera module 100 according to a preferred embodiment of the present invention, each of first magnetic sensor 180A, second magnetic sensor 180D, and third magnetic sensor 180B is disposed inside the corresponding one of four second coils 170A to 170D. Thus, first magnetic sensor 180A, second magnetic sensor 180D, and third magnetic sensor 180B can also be disposed in the space where four second coils 170A to 170D are disposed. Thus, the size of camera module 100 can be reduced.

In camera module 100 according to a preferred embodiment of the present invention, second magnet 141 is provided on lens module 120, and fourth magnetic sensor 181 is provided on fixed portion 110. Thus, a connection wire between fourth magnetic sensor 181 and control unit 10 can be provided on fixed portion 110. Thus, the structure of camera module 100 can be simplified.

In the description of the above preferred embodiments, the structures that can be combined may be combined with each other.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A camera module comprising:
four first magnets that are provided on a fixed portion with a position fixed and are positioned with a space therebetween;
a lens module that includes a lens with an optical axis and is movable in a direction of the optical axis relative to the fixed portion;
four first coils positioned on the lens module so as to respectively face the four first magnets;
a substrate that is movably supported with respect to the fixed portion and includes an image sensor mounted thereon;
four second coils positioned on the substrate so as to respectively face the four first magnets;
a first magnetic sensor positioned on the substrate so as to face one first magnet of the four first magnets and to detect a strength of a magnetic field to be applied from the first magnet;
a second magnetic sensor positioned on the substrate so as to face one first magnet of the four first magnets and to detect the strength of the magnetic field to be applied from the first magnet;
a third magnetic sensor positioned on the substrate so as to face one first magnet of the four first magnets and to detect a displacement in an application direction of the magnetic field to be applied from the first magnet in an in-plane direction that is orthogonal to the direction of the optical axis;
a second magnet that is provided on one of the lens module and the fixed portion; and
a fourth magnetic sensor positioned on the other of the lens module and the fixed portion so as to face the second magnet and to detect a strength of a magnetic field to be applied from the second magnet; wherein
the four first coils and the four first magnets are operable to generate a driving force to cause the lens module to move in the direction of the optical axis;
the four second coils and the four first magnets are operable to generate a driving force to cause the substrate to move in a first direction in the in-plane direction, a driving force to cause the substrate to move in a second direction that is orthogonal to each of the direction of the optical axis and the first direction, and a driving force to cause the substrate to rotate about the optical axis;
a displacement of the substrate in the first direction is detected based on the strength of the magnetic field detected by the first magnetic sensor;
a displacement of the substrate in the second direction is detected based on the strength of the magnetic field detected by the second magnetic sensor;
a displacement of the substrate around the optical axis is detected based on the displacement of the magnetic field in the application direction detected by the third magnetic sensor; and
a displacement of the lens module in the direction of the optical axis is detected based on the strength of the magnetic field detected by the fourth magnetic sensor.

2. The camera module according to claim 1, wherein the four first magnets are positioned to have 4-fold rotational symmetry about the optical axis when viewed from the direction of the optical axis.

3. The camera module according to claim 2, wherein the four second coils are positioned to have 4-fold rotational symmetry when viewed from the direction of the optical axis.

4. The camera module according to claim 1, wherein each of the four first magnets is a quadrupole magnet.

5. The camera module according to claim 1, wherein each of the first magnetic sensor, the second magnetic sensor, and the third magnetic sensor is positioned inside a corresponding one of the four second coils.

6. The camera module according to claim 1, wherein
the second magnet is provided on the lens module; and
the fourth magnetic sensor is provided on the fixed portion.

7. The camera module according to claim 1, wherein the fixed portion includes a rectangular or substantially rectangular flat plate including an opening with a rectangular or substantially rectangular shape at a center.

8. The camera module according to claim 1, wherein each of the four first magnets is a dipole magnet.

9. The camera module according to claim 1, wherein each of the first magnetic sensor, the second magnetic sensor, the third magnetic sensor, and the fourth magnetic sensor includes magnetic resistance effect elements defining a bridge circuit.

10. The camera module according to claim 9, wherein the magnetic resistance effect elements include a Giant Magneto Resistance element or an Anisotropic Magneto Resistance element.

11. The camera module according to claim 1, wherein each of the first magnetic sensor, the second magnetic sensor, the third magnetic sensor, and the fourth magnetic sensor includes a Hall element.

12. The camera module according to claim 1, further comprising a controller to cause the camera module to perform an optical image stabilization to correct shaking.
